(19) United States
(12) Patent Application Publication
(10) Pub. No.: US 2008/0083486 A1
(43) Pub. Date: Apr. 10, 2008

(54) Method of making silicon rubber product with adhesive layer on the back thereof

(75) Inventor: Wen-Fu Yang, Changhua County (TW)

Correspondence Address: BIRCH STEWART KOLASCH & BIRCH, PO BOX 747, FALLS CHURCH, VA, 22040-0747, US

(73) Assignee: LEE BOU LABEL ENTERPRISE CO., LTD.

(21) Appl. No.: 11/543,035

(22) Filed: Oct. 5, 2006

(51) Int. Cl. B29C 43/18

(52) U.S. Cl. 156/245; 264/259; 264/331.11; 264/255; 264/265

(57) ABSTRACT

A method of making a silicon rubber product with an adhesive layer on a back thereof includes the steps of: providing silicon rubber in a cavity of a mold, and then providing a solid adhesive film on the silicon rubber. After that, the mold is treated by hot molding to mold the silicon rubber and combine the silicon rubber and the adhesive film together. After hot molding treatment, it will get a silicon rubber product with an adhesive layer on a back thereof.

### BACKGROUND OF THE INVENTION

1. Field of the Invention

The present invention relates generally to a method of making silicon rubber products, and more particular to a method of making a silicon rubber product with an adhesive layer on the back thereof.

2. Description of the Related Art

There usually are plastic tags or labels on clothes, shoes or back bags. The tag has a substrate and a pattern thereon to show the trademark or other information. These tags usually have an adhesive layer on a back thereof, which may be hot-melt adhesive (so called thermosensitive adhesive) or pressure sensitive adhesive, to attach the tags on predetermined objects.

U.S. Pat. No. 5,849,145 disclosed a method of smearing hot-melt adhesive on the plastic film. The method includes the steps of dosing hot-melt adhesive on a roller and then rolling the roller on the plastic film to apply the hot-melt adhesive onto the plastic film.

The conventional tags are added with the adhesive layer after it is molded, and then a paper is attached on the adhesive layer. Such process is complex, and has a higher cost.

### SUMMARY OF THE INVENTION

The primary objective of the present invention is to provide a method of making a silicon rubber product with an adhesive layer, which the product and the adhesive layer are formed in the same step.

According to the objective of the present invention, a method of making a silicon rubber product with an adhesive layer on a back thereof includes the steps of: providing silicon rubber in a cavity of a mold, and then providing a solid adhesive film on the silicon rubber. After that, the mold is treated by hot molding to mold the silicon rubber and combine the silicon rubber and the adhesive film together. After hot molding treatment, it will get a silicon rubber product with an adhesive layer on a back thereof.

### BRIEF DESCRIPTION OF THE DRAWINGS

FIG. 1 is a sectional view of the mold of a preferred embodiment of the present invention;

FIG. 2 is a sketch diagram of the present invention, showing providing RTV rubber in the first pattern layer of the bottom member of the mold;

FIG. 3 is a sketch diagram of the present invention, showing providing RTV rubber in the second pattern layer of the bottom member of the mold;

FIG. 4 is a sketch diagram of the present invention, showing providing HTV rubber in the base layer of the bottom member of the mold;

FIG. 5 is a sketch diagram of the present invention, showing providing the adhesive film on the HTV rubber;

FIG. 6 is a sketch diagram of the present invention, showing covering the upper mold to cut the adhesive film off;

FIG. 7 is a sketch diagram of the present invention, showing the mold under hot molding molding;

FIG. 8 is a perspective view of the silicon rubber product made by the method of the present invention; and

FIG. 9 is a sectional view of FIG. 8.

### DETAILED DESCRIPTION OF THE INVENTION

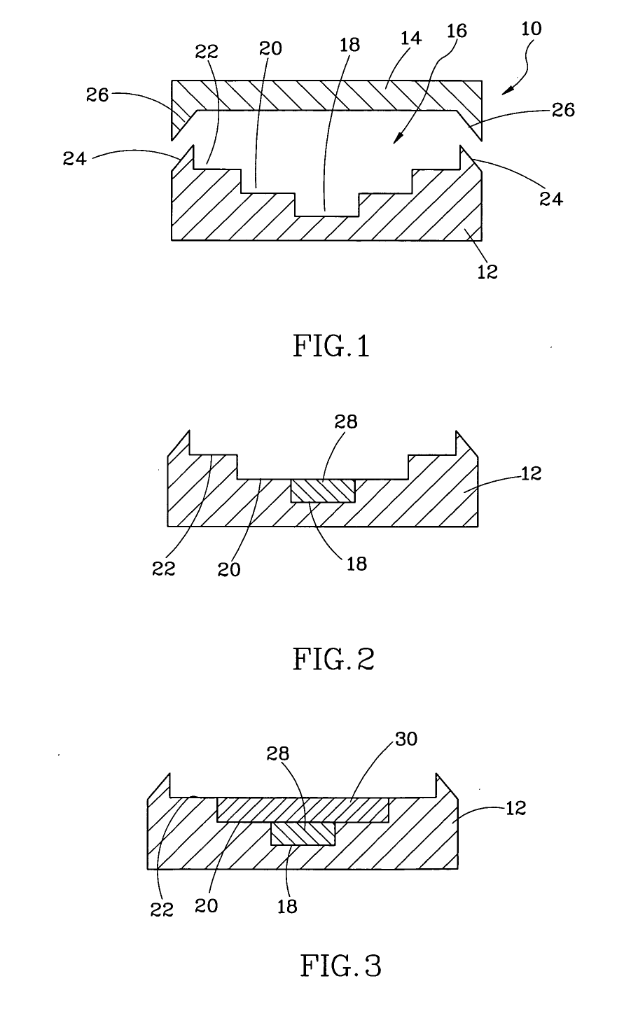

As shown in FIG. 1 to FIG. 7, a method of making a silicon rubber product with an adhesive layer on a back thereof includes the steps of:

a) Preparing a mold 10.

As shown in FIG. 1, the mold 10 has a bottom member 12 and an upper member 14. The bottom member 12 has a cavity 16, which consists of, from bottom to top, a first pattern layer 18, a second pattern layer 20 and a base layer 22. The bottom member 12 further includes a blade portion 24 around the cavity 16. The upper member 14 includes a blade portion 26 associated with the blade portion 24 of the bottom member 12.

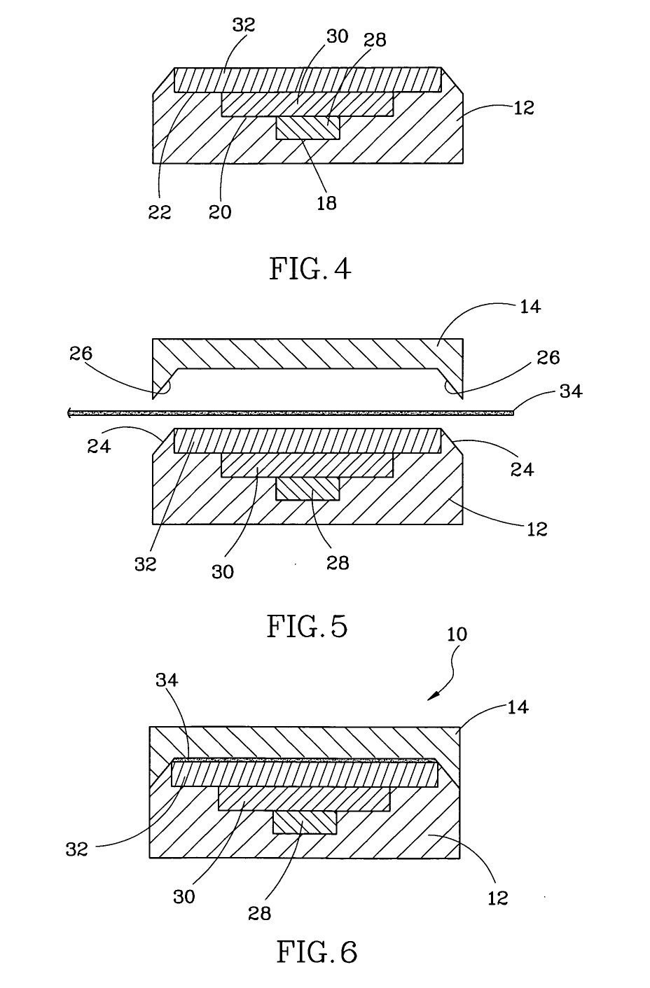

b) Providing silicon rubber in the cavity 16 of the bottom member 12 of the mold 10. This step includes sub-steps hereunder:
I. Dosing molten room temperature vulcanization (RTV) silicon rubber 28 in the first pattern layer 18 of the bottom member 12 of the mold 10.
As shown in FIG. 2, microinjection and automatic control process is applied in this step to dose RTV silicon rubber 28 in the first pattern layer 18 of the bottom member 12. The RTV silicon rubber 28 may has various colors to be dosed in different portions of the first pattern layer 18 according to designation.
II. Heating the RTV silicon rubber 28 for vulcanization.
The bottom member 12 is sent to a stove (not shown) for heating under 120° C. to 180° C. for 15 second to 25 second. The RTV silicon rubber 28 will be vulcanized.
III. Cooling the RTV silicon rubber 28.
After heating, the bottom member 12 is sent to a cooling device (not shown) for cooling. The cooling device has liquid (usually is water) of 5° C. to 20° C. flowing to cool the RTV silicon rubber 28 to room temperature.
IV. Dosing molten RTV silicon rubber 30 in the second pattern layer 20 of the bottom member 12 of the mold 10, and then heating and cooling the bottom member 12, as shown in FIG. 3.
V. As shown in FIG. 4, putting a high temperature vulcanization (HTV) silicon rubber block 32 with a size and shape similar to the base layer 22 of the bottom member 12 of the mold 10 in the base layer 22.

c) As shown in FIG. 5, placing an adhesive film 34 on the HTV silicon rubber 32. The adhesive film 34 is a solid hot-melt adhesive or thermosensitive adhesive or pressure sensitive adhesive band-like elongated film. The width and length of the adhesive film 34 are greater than that of the cavity 16 of the bottom member 12. As shown in FIG. 6, when covering the upper member 14, the blade portions 24 and 26 will work like a scissors to cut the adhesive film 34 to have an adhesive piece 34a with a size and shape similar to the HTV silicon rubber 32 left in the mold 10. The upper member 14 presses the adhesive piece 34a on the HTV silicon rubber 32.

Of course, the adhesive film 34 may be cut off to have several adhesive layer 34a with size and shape of the HTV silicon rubber 32 prior to being placed on the HTV silicon rubber 32. The process of the embodiment meets the requirement of mass production.

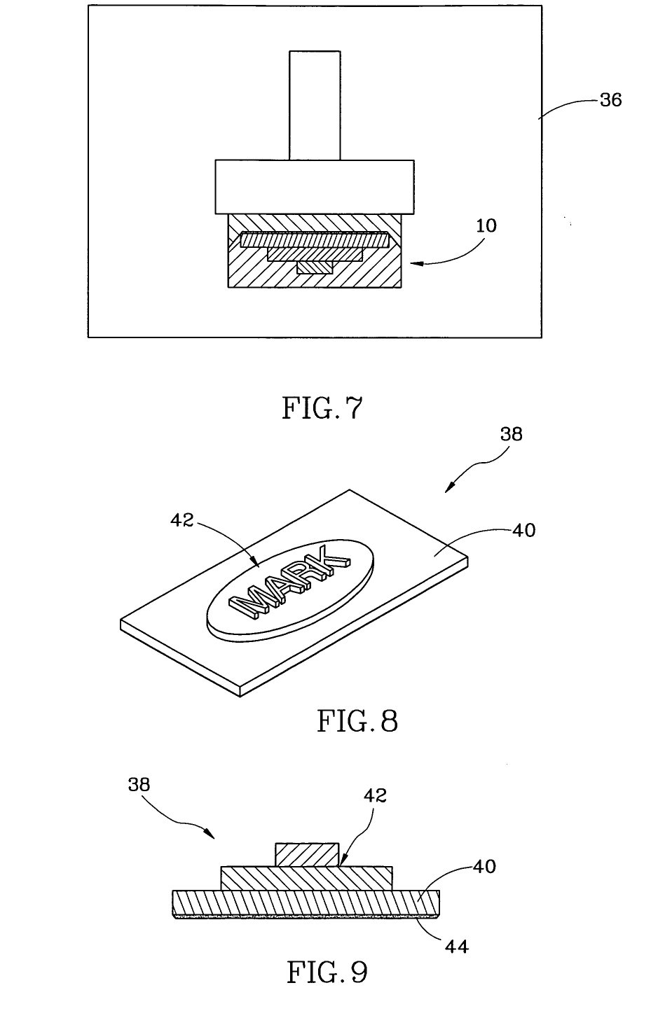

d) As shown in FIG. 7, the mold 10 is sent to a chamber 36 for hot molding treatment. In the hot molding treatment, the RTV silicon rubbers 28, 30, the HTV silicon rubber 32 and the adhesive piece 34a will be integrated into a single unit.

e) At last, opening the mold 10 will get a silicon rubber product 38. as shown in FIG. 8 and FIG. 9, the silicon rubber product 38 includes a base 40, which is formed from the HTV silicon rubber 32, a two-stage pattern 42, which is formed from the RTV silicon rubbers 28, 30, on a front of the base 40, and an adhesive layer 44, which is formed from the adhesive film 34, on a back of the base 40.

The silicon rubber products 38 made by the method of the present invention have the base 40, the pattern 42 and the adhesive layer 44 formed in the same process that decrease the cost of fabrication. The silicon rubber products 38 may be heated and pressed to melt the adhesive layer 44, such that the silicon rubber products 38 may be attached on objects made of fabrics, leather, plastic, metal, glass or other materials.

What is claimed is:

1. A method of making a silicon rubber product, comprising the steps of:
a) preparing a mold having a bottom member and an upper member, wherein the bottom member has a cavity;
b) providing silicon rubber in the cavity of the bottom member of the mold;
c) providing a solid adhesive film on the silicon rubber;
d) covering the upper member onto the bottom member and heating and pressing the mold for molding the silicon rubber and coupling the silicon rubber and the adhesive film together; and
e) cooling the mold to take a silicon rubber product with an adhesive layer on a back thereof from the mold.

2. The method as defined in claim 1, wherein the cavity of the bottom member of the mold includes a pattern layer and a base layer, and the silicon rubber includes a pattern material and a base material, and the step b includes the sub-steps of:
I. dosing the pattern material in the pattern layer;
II. heating the pattern material for vulcanization;
III. cooling the pattern material; and
IV. putting the base material in the base layer.

3. The method as defined in claim 2, wherein the pattern material is room temperature vulcanization silicon rubber and the base material is high temperature vulcanization silicon rubber.

4. The method as defined in claim 1, wherein the cavity of the bottom member of the mold includes a first pattern layer, a second pattern layer and a base layer, and the silicon rubber includes a first pattern material, a second pattern material and a base material, and the step b includes the sub-steps of:
I. dosing the first pattern material in the first pattern layer;
II. heating the first pattern material for vulcanization, and then cooling first pattern material;
III. dosing the second pattern material in the second pattern layer;
IV. heating the second pattern material for vulcanization, and then cooling second pattern material; and
V. putting the base material in the base layer.

5. The method as defined in claim 4, wherein the first and second pattern materials are room temperature vulcanization silicon rubber and the base material is high temperature vulcanization silicon rubber.

6. The method as defined in claim 1, wherein the adhesive film is an elongated band and is cut off to have an adhesive piece with a shape similar to the silicon rubber to be put on the silicon rubber.

7. The method as defined in claim 1, wherein the bottom member has a blade portion around the cavity, and the upper member has a blade portion associated with the blade portion of the bottom member, such that the blade portions cut the adhesive film off and leave the adhesive piece in the mold when covering the upper member onto the bottom member.

8. The method as defined in claim 1, wherein the adhesive film is made of hot-melt adhesive, thermosensitive adhesive or pressure sensitive adhesive.
